(19) United States
(12) Patent Application Publication
(10) Pub. No.: US 2025/0242617 A1
(43) Pub. Date: Jul. 31, 2025

(54) UNIT

(71) Applicant: Masanori HIRANO, Kanagawa (JP)

(72) Inventor: Masanori HIRANO, Kanagawa (JP)

(21) Appl. No.: 19/021,251

(22) Filed: Jan. 15, 2025

(30) Foreign Application Priority Data
Jan. 31, 2024 (JP) 2024-012547
Oct. 7, 2024 (JP) 2024-175536

(51) Int. Cl. B41J 29/02; B41J 3/407

(52) U.S. Cl. CPC B41J 29/02; B41J 3/4078

(57) ABSTRACT

A unit that is attachable to and detachable from a printing apparatus is provided. The unit includes a support to support a printing medium, and the support comprises a water-absorbent material.

### CROSS-REFERENCE TO RELATED APPLICATIONS

This patent application is based on and claims priority pursuant to 35 U.S.C. § 119 (a) to Japanese Patent Application Nos. 2024-012547 and 2024-175536, filed on Jan. 31, 2024 and Oct. 7, 2024, respectively, in the Japan Patent Office, the entire disclosure of each is hereby incorporated by reference herein.

### BACKGROUND

### Technical Field

The present disclosure relates to a unit.

### Related Art

In recent years, Direct to Garment (DTG) printing technology is widely used as a printing technology that uses inkjet technology to directly discharge water-based pigment ink onto a fabric to print the fabric.

For example, a printing apparatus has been proposed to facilitate the work for setting a fabric. Such a printing apparatus includes a cassette-type platen including a fabric holding member, a receiving member, and a printing member. In the printing apparatus, it is possible to switch from printing to thermal fixing processing by simply inserting and removing the cassette, in a state where the printing fabric (a T-shirt) remains set.

### SUMMARY

The present disclosure described herein provides a unit that is attachable to and detachable from a printing apparatus. The unit includes a support to support a printing medium, and the support comprises a water-absorbent material.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a printing method in a DTG printer of a related art;

FIG. 2 is a schematic explanatory diagram illustrating a process in which a bleeding mark occurs in a related art;

FIG. 3A is an image of platen staining occurring in DTG printing of a related art;

FIG. 3B is an image of a bleeding mark occurring in DTG printing of a related art;

FIG. 4 is a schematic explanatory diagram illustrating a printing method using a unit;

FIG. 5A is a schematic explanatory diagrams illustrating a joint in a unit;

FIG. 5B is a schematic explanatory diagram illustrating the structure of a pallet bottom portion in a unit;

FIG. 5C is a schematic explanatory diagram illustrating the structure of a pallet bottom portion in a unit;

FIG. 6 is a schematic explanatory diagram illustrating a process in which the occurrence of a bleeding mark is prevented by a support in a unit;

FIG. 7A is a schematic explanatory diagram illustrating a support having a slope shape in a unit;

FIG. 7B is a schematic explanatory diagram illustrating a support having a round shape in a unit;

FIG. 8A is a schematic explanatory diagram illustrating a method of attaching a support to a pallet in a unit;

FIG. 8B is a schematic explanatory diagram illustrating a method of attaching a support to a pallet in a unit;

FIG. 8C is a schematic explanatory diagram illustrating a method of attaching a support to a pallet in a unit;

FIG. 9A is a schematic perspective view of a DTG printer incorporating a pretreatment liquid discharge head, as a printing apparatus;

FIG. 9B is a schematic explanatory view of the DTG printer of FIG. 9A incorporating the pretreatment liquid discharge head, viewed from above;

FIG. 9C is a schematic cross-sectional diagram illustrating an operation of a stage in the DTG printer of FIG. 9A incorporating the pretreatment liquid discharge head;

FIG. 10A is a schematic perspective view of a DTG printer compatible with a media mounting cassette, as a printing apparatus; and

FIG. 10B is a schematic perspective view of the DTG printer of FIG. 10A using a media mounting cassette.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present disclosure, a unit is provided that prevents the occurrence of platen staining during printing and the appearance of bleeding marks on printed images.

A typical printing method in a DTG printer of the related art includes applying a pretreatment liquid to a printing medium, and then, applying color printing ink and heating and fixing the ink. The pretreatment liquid is applied to the printing medium to firmly fix a colorant, and aids in fixing ink that does not easily adhere to fabric fibers (such as white pigment ink), and fixing pigment ink to polyester fibers and the like, to which pigment ink alone does not adhere.

When the printing medium has a color other than white (such as black, red, blue, and green), the amount of the pretreatment liquid and the color printing ink being used tend to be greater than when the printing medium is white.

This is because, when the printing medium has a color other than white, to reduce the influence on the color reproducibility in the printed image, after applying a pretreatment liquid to the printing medium and before applying the color printing ink, it is desired to apply white ink to the printing medium, to form a white ink layer (base layer). Another factor is that the white ink layer (base layer) is preferably formed thicker than the color printing ink layer, to prevent the color of the printing medium from showing through and affecting the color reproducibility of the printed image, and to prevent the white ink layer from peeling off due to friction or washing, as it is not easy to fix white ink on some printing media. The amount of pretreatment liquid applied to the printing medium in advance also increases in proportion to the increase in the amount of white ink being used.

Here, in the technology of the related art described above, there is a concern that the white ink or the pretreatment liquid may bleed into the backing fabric of the printing medium during printing, causing stains on the platen. This is due to the increased amounts of the white ink and the pretreatment liquid being used. If stains are formed on the platen by the white ink or the pretreatment liquid, secondary contamination may occur, such as in a case where the white ink or the pretreatment liquid on the platen is retransferred and contaminates the backing fabric of the printing medium, or spouts onto the surface of the printing medium during press fixing. The secondary contamination may be avoided by temporarily removing the printing medium immediately after printing and cleaning the platen surface. However, this increases the number of steps performed to clean the platen and reset the printing medium, which reduces the productivity.

Further, there is a concern that, when the printed image is heated and fixed, a solvent (such as glycerin and propanediol) contained in the pretreatment liquid and the ink (the white ink and the color printing ink) may spread toward the surface of the printing medium when water evaporates, so that a bleeding mark is formed in the periphery of the printed image after heating. This is because the boiling point of the solvent is higher than the temperature during heat-fixing, so that the solvent does not evaporate but remains in the periphery of the printed image. If a bleeding mark occurs, the appearance of the product deteriorates and the quality of the product decreases.

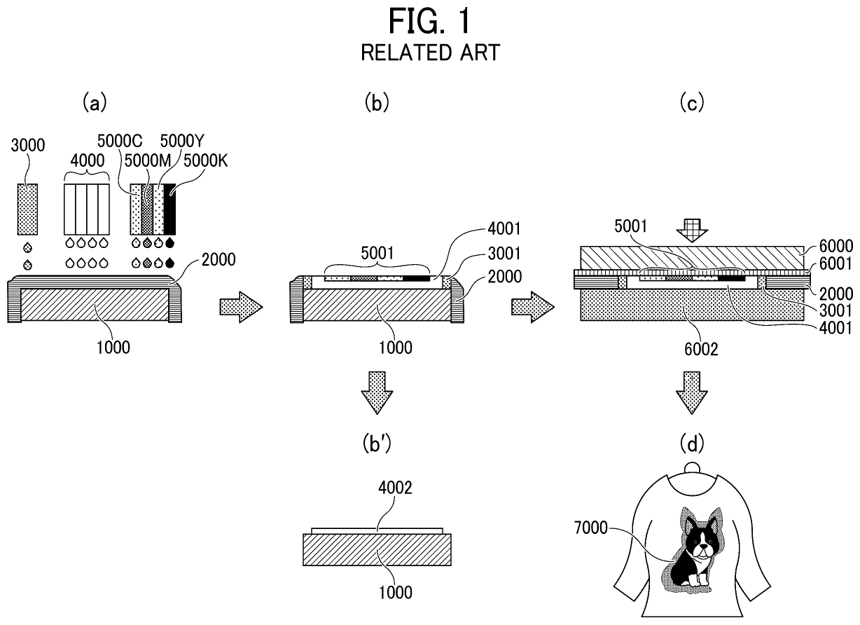

Here, the issues of platen staining during printing and bleeding marks appearing on printed images in the technology of the related art will be described with reference to FIGS. 1 to 3B.

FIG. 1 is a schematic diagram illustrating a printing method in a DTG printer of the related art. FIG. 1 illustrates an example in which a printing medium has a color other than white.

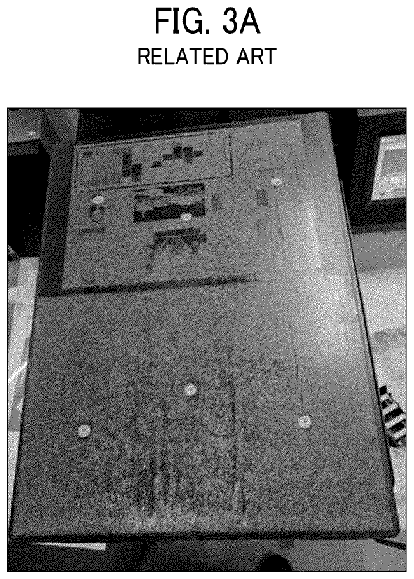

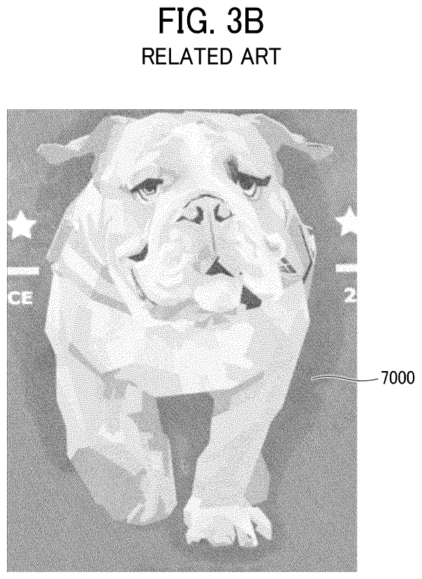

In DTG printing of the related art, as described above, a pretreatment liquid, a white ink, and color inks are applied consecutively to a printing medium 2000 supported on a platen 1000. The pretreatment liquid is discharged from a pretreatment liquid head 3000, the white ink is discharged from a white ink head 4000, and the color inks are discharged from various types of heads 5000 (5000C, 5000M, 5000Y, and 5000K) corresponding to the colors (see FIG. 1(a)). A pretreatment liquid layer 3001 is formed from the pretreatment liquid, a white ink layer 4001 is formed from the white ink, and a color ink layer 5001 corresponding to the colors is formed from the color inks (see FIG. 1(b)). At this time, when the printing medium 2000 is removed from the platen 1000, bleeding ink 4002 such as the white ink and the pretreatment liquid bleeds onto the platen and causes stains on the platen (see FIG. 1 (b′)). FIG. 3A is an image of platen staining occurring in DTG printing of the related art.

Next, a non-permeable paper sheet 6001 is placed on each of the formed layers, and then, is fixed and dried from above by using a heat press machine 6000 to obtain a printed image (see FIG. 1(c)). A bleeding mark 7000 is formed in the periphery of the obtained printed image. FIG. 3B is an image illustrating a bleeding mark occurring in DTG printing of the related art.

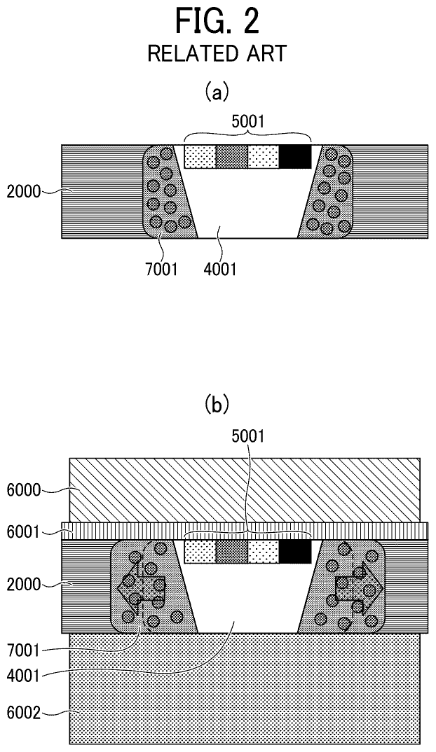

FIG. 2 is a schematic explanatory diagram illustrating a process in which a bleeding mark occurs. Note that FIG. 2(a) corresponds to FIG. 1(b), and FIG. 2(b) corresponds to FIG. 1(c).

An image forming portion of the printing medium 2000 includes pigment components of the white ink layer 4001 and the color ink layer 5001. Therefore, water and a solvent component 7001 diffuse toward the periphery of the image forming portion (see FIG. 2(a)). When a heat-fixing process is performed in this state, an up-down direction is sealed by a lower receiving platform 6002 of the heat press machine 6000 and the non-permeable paper sheet 6001 inserted to prevent transfer of the printed surface. Thus, water vapor is discharged in a planar direction of the printing medium 2000, and the solvent component 7001 also moves in the planar direction. The heating and fixing temperature at this time is set lower than the volatilization temperature of the solvent, to prevent color migration from the printing medium (prevents the original dye that dyes the printing medium from sublimating and migrating), and thus, only the water evaporates. As a result, the solvent component 7001 remains in the printing medium 2000 and forms the bleeding mark 7000.

Normally, such stains on the platen are desirably cleaned each time platen staining occurs. In a proposed technique, a brush-shaped support is provided on the platen to support the backing of the fabric at points, so that the contamination of the platen by ink bleeding into the backing is minimized. However, this technique has a disadvantage that ink that bleeds into the backing remains in the backing of the fabric. Further, because the brush-shaped support is not strong enough to withstand the pressing pressure, the media needs to be removed during heat pressing, which poses a disadvantage of further contamination caused by ink that has bled into the backing and remains in the backing of the fabric. Moreover, the appearance of bleeding marks was not prevented.

That is, in DTG printers of the related art, platen staining occurring during printing and bleeding marks appearing on printed images are not taken into account, and thus, there is room for improvement.

The unit according to an embodiment of the present disclosure is a unit that is attachable to and detachable from a printing apparatus, and the unit includes a support to support a printing medium, and the support comprises a water-absorbent material.

Such a unit can sufficiently resolve various types of concerns in the related art. More specifically, the unit prevents the occurrence of platen staining during printing and the appearance of bleeding marks on printed images.

Embodiments of the present invention will be described in detail below.

Note that the present invention is not limited to the embodiments described below, and may be changed within the scope conceivable by a person skilled in the art, including other embodiments, additions, modifications, omissions, and the like. The obtained embodiments are included within the scope of the present invention, as long as the functions and effects of the present invention are achieved in any aspect.

### (Unit)

The unit according to an embodiment of the present disclosure is a unit that is attachable to and detachable from a printing apparatus, and the unit includes a support to support a printing medium, and the support comprises a water-absorbent material.

The unit may include other members, if desired.

The printing apparatus is not particularly limited and can be selected appropriately according to a purpose, as long as the printing apparatus is an apparatus that makes prints on a printing medium. For example, the printing apparatus may include a printer that applies ink and a pretreatment device that applies a pretreatment liquid.

According to some embodiments, the unit may be a pallet that is attachable to and detachable from a stage of the printing apparatus. To allow for implementation of the entire process from printing to fixing, the pallet preferably has a structure by which the pallet can be attached to and detached from the stage of the printing apparatus (e.g., the printer and the pretreatment device) and the stage of a heating and fixing device. Even more preferably, the pallet has a structure by which the pallet can be placed on the stage of the printing apparatus (e.g., the printer and the pretreatment device) and the stage of the heating and fixing device.

According to some embodiments, the unit may be a cassette that is attachable to and detachable from the printing apparatus. To allow for implementation of the entire process from printing to fixing, the cassette preferably has a structure by which the cassette can be attached to and detached from the printing apparatus (e.g., the printer and the pretreatment device) and the heating and fixing device. Even more preferably, the cassette has a structure by which the cassette can be inserted into the printing apparatus (e.g., the printer and the pretreatment device) and the heating and fixing device.

Here, embodiments of the present invention will be described with reference to the drawings. However, the applications of the present invention are not limited to these embodiments in any way. In the drawings, identical or similar constituent components are denoted by identical or similar reference numerals, and overlapping parts of the description may be omitted. Further, the numbers, positions, shapes, and the like of the following constituent members are not limited to these embodiments, and include any numbers, positions, shapes, and the like that are preferable for implementing the present invention.

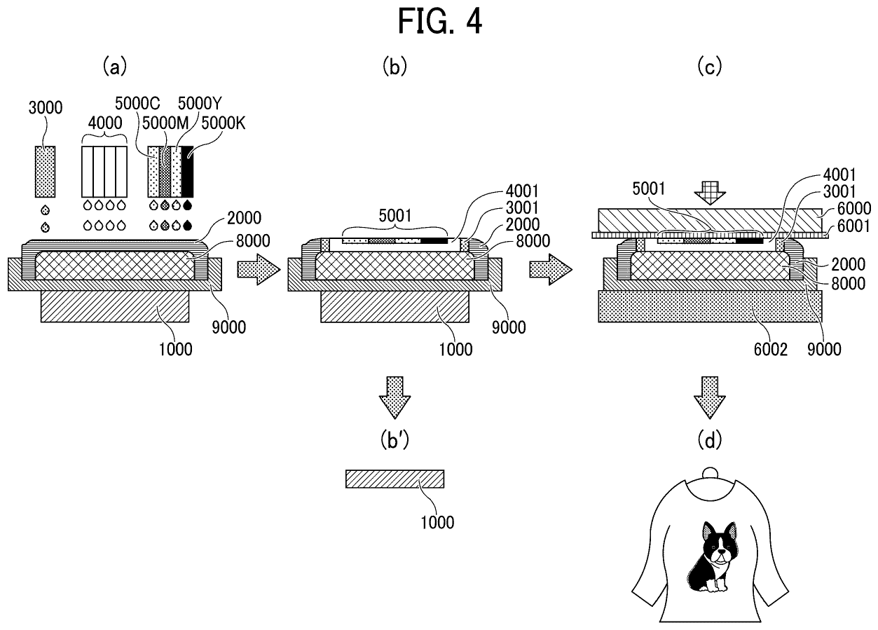

FIG. 4 is a schematic explanatory diagram illustrating a printing method using a unit according to an embodiment of the present disclosure.

A printing apparatus illustrated in FIG. 4(a) has a similar configuration to the DTG printer illustrated in FIG. 1(a), except that a pallet 9000 including a support 8000 to support the printing medium 2000 is provided on the platen 1000.

The pretreatment liquid, the white ink, and the color ink are applied consecutively to the printing medium 2000 supported by the support 8000 included in the pallet 9000. The pretreatment liquid is discharged from the pretreatment liquid head 3000, the white ink is discharged from the white ink head 4000, and the color inks are discharged from the various types of heads 5000 (5000C, 5000M, 5000Y, and 5000K) corresponding to the colors (see FIG. 4(a)). The pretreatment liquid layer 3001 is formed from the pretreatment liquid, the white ink layer 4001 is formed from the white ink, and the color ink layer 5001 corresponding to the colors is formed from the color inks (see FIG. 4(b)). At this time, when the pallet 9000 is removed from the platen 1000, the staining of the platen, which occurs in the printing method using a DTG printer of the related art, is not observed (see FIG. 4 (b′)). Next, the non-permeable paper sheet 6001 is placed on each of the formed layers, and then, is fixed and dried from above by using the heat press machine 6000 to obtain a printed image (see FIG. 4(c)). In the obtained printed image, the bleeding mark 7000, which occurs in the printing method using the DTG printer of the related art, is not observed (see FIG. 4(d)).

The pretreatment liquid head 3000, the white ink head 4000, and the various types of heads 5000 corresponding to the colors, which serve as dischargers, are not particularly limited, but preferably use an inkjet method. For example, a blade coating method, a gravure coating method, a bar coating method, a roll coating method, a dip coating method, a curtain coating method, a slide coating method, a die coating method, a spray coating method, and the like can be adopted.

The heat press machine 6000 is an example of a heater. The heater is not particularly limited, and can be appropriately selected according to a purpose. A commercially available example of such a heat press machine includes a machine by the product name of TP700A 22L (manufactured by Horizon).

The unit is not particularly limited and can be appropriately selected according to a purpose, as long as the unit includes a support to support the printing medium and is attachable to and detachable from the printing apparatus.

By using a unit having such a structure, the occurrence of platen staining can be prevented during printing of an image. Further, the entire process in the printing method can be implemented without attaching and detaching the printing medium, and thus, the productivity is increased.

The size, the shape, the material, and the structure of the unit are not particularly limited and can be appropriately selected according to a purpose, as long as the unit is attachable to and detachable from the stage of the printing apparatus and does not interfere with the operation of the printing apparatus.

The unit preferably includes a joint that is attachable to and detachable from the stage of the printing apparatus. Thus, the unit can be easily attached to and detached from the printing apparatus.

The joint is not particularly limited and can be appropriately selected according to a purpose, as long as the joint is a member by which the unit can be attached to and detached from the stage of the printing apparatus. Examples of the joint include, but are not limited to, a magnet and a hook-and-loop fastener.

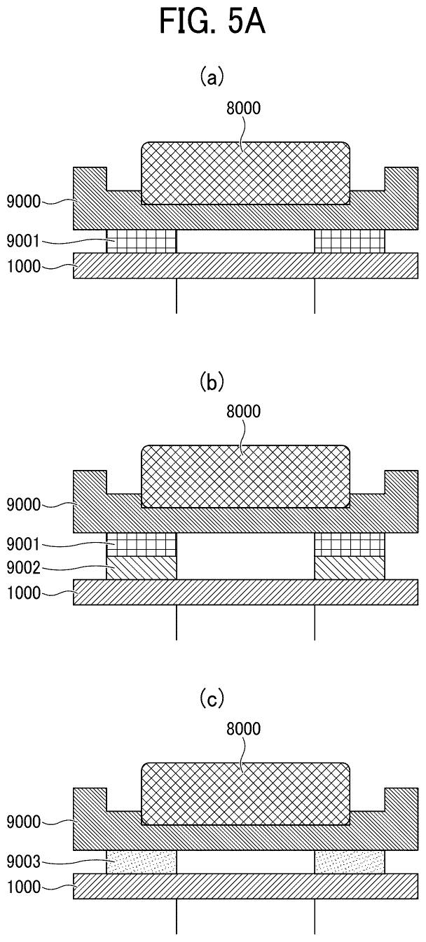

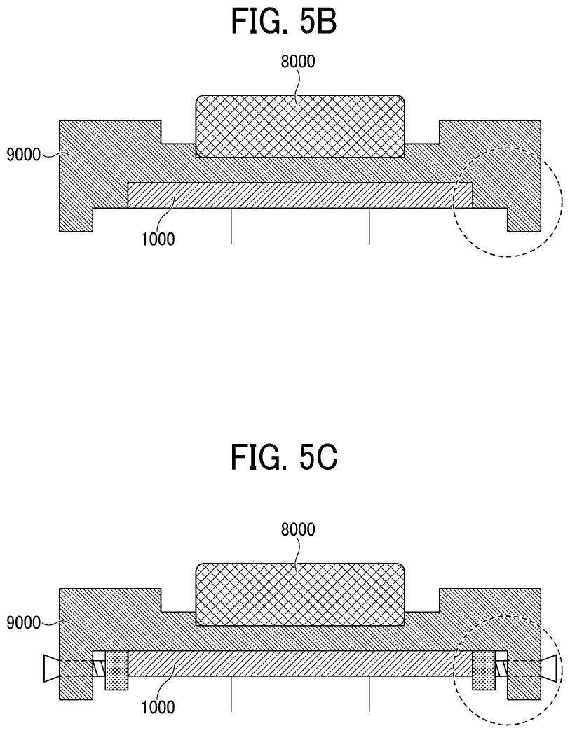

FIG. 5A is a schematic explanatory diagram illustrating examples of the joint in the unit.

FIG. 5A illustrates examples in which the pallet and the platen (platen stage) are fixed using a magnet. When the platen includes a metal, the joint may include a magnet 9001 that is placed on a bottom portion of the pallet (see FIG. 5A (a)). When the platen does not include a metal, the joint may include the magnet 9001 that is placed on the bottom portion of the pallet and a metal 9002 that is placed on the platen (see FIG. 5A (b)). Further, the joint may include a pair of hook-and-loop fasteners 9003 that is provided on the pallet and the platen (see FIG. 5A (c)).

The unit preferably includes a frame at a bottom portion thereof, and the frame covers an outer edge of the stage of the printing apparatus. In other words, the pallet preferably includes a fitting frame at the bottom portion of the pallet, and the fitting frame fits into the stage of the printing apparatus.

FIG. 5B is a schematic explanatory diagram illustrating the structure of a pallet bottom portion in the unit.

FIG. 5B illustrates an example in which the bottom portion of the pallet includes a frame covering an outer edge of the platen stage. An area surrounded by a dotted line in FIG. 5B indicates the frame. The size, the shape, the material, and the structure of the frame are not particularly limited and can be appropriately selected according to a purpose, as long as the frame can be fitted into the platen stage.

The unit preferably includes a clamping mechanism that sandwiches the outer edge of the stage of the printing apparatus.

FIG. 5C is a schematic explanatory diagram illustrating the structure of the pallet bottom portion in the unit.

FIG. 5C illustrates an example in which the pallet includes a clamping mechanism that sandwiches the outer edge of the stage of the printing apparatus. An area surrounded by a dotted line in FIG. 5C indicates the clamping mechanism. The number of clamping mechanisms, the size, the shape, the material, and the structure of the clamping mechanism are not particularly limited and can be appropriately selected according to a purpose.

### <Support>

In the present disclosure, the support comprises a water-absorbent material. Such a support comprising a water-absorbent material prevents the occurrence of platen staining during printing and the occurrence of bleeding marks on the printed image.

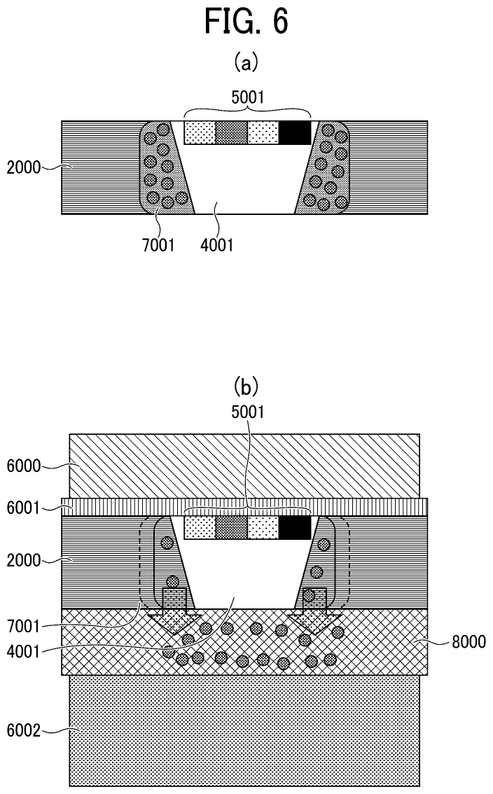

FIG. 6 is a schematic explanatory diagram illustrating a process in which the occurrence of a bleeding mark is prevented by a support in the unit.

FIG. 6(b) illustrates a similar state to FIG. 2(b), except that the support 8000 to support the printing medium 2000 is provided.

An image forming portion of the printing medium 2000 includes pigment components of the white ink layer 4001 and the color ink layer 5001. Therefore, water and the solvent component 7001 diffuse toward the periphery of the image forming portion (see FIG. 6(a)). When a heat-fixing process is performed in this state, the support 8000 that is water-absorbent functions as a release route (or an absorption destination) for vapor, and thus, prevents water and the solvent component 7001 from diffusing in the planar direction of the printing medium 2000 (see FIG. 6(b)). Further, the support 8000 absorbs ink bleeding from the printing medium 2000, and thus, prevents stains on the platen.

The material of the support is not particularly limited and may be appropriately selected according to a purpose, as long as the material contains the water-absorbent material mentioned above, and the material may contain other members such as pulp fiber and lime. The water-absorbent material is not particularly limited and can be appropriately selected according to a purpose. Examples of the water-absorbent material include, but are not limited to, polyester fabric (water absorption capacity: about 1.2 mL/100 g), cotton fabric (water absorption capacity: about 25 mL/100 g), diatomaceous earth (calcined product, water absorption capacity: about 100 to 300 mL/100 g), volcanic rocks (processed product, water absorption capacity: about 150 to 450 mL/100 g), and highly absorbent polymers (water absorption capacity: about 20,000 to 100,000 mL/100 g). The diatomaceous earth, the volcanic rocks, and the highly absorbent polymer have much higher water absorption capacity than the polyester fabric (water absorption capacity: about 1.2 mL/100 g) and the cotton fabric (water absorption capacity: about 25 mL/100 g), which are commonly used as T-shirt fabrics. Herein, the term “water absorption capacity” indicates the amount of water that can be absorbed per 100 g of material.

Note that the polyester fabric and the cotton fabric may have spaces formed by a weaving method, such as in terry cloth, which makes it possible to adjust the water absorption capacity. However, taking into consideration that the spaces may be squeezed by a heat press machine used as a heater, it is preferable to use a material having a strength at which the spaces are not squeezed even when the material is pressed, or a material in which the water absorption capacity is not adjusted by spaces. Further, it is preferable to use a material having a porous structure that is not affected by the pressing force (for example, 4 N/cm²) of the heat press machine.

Among these materials, a highly water-absorbent material having a water absorbency of 100 mL/100 g or more is preferred.

The highly water-absorbent material is not particularly limited and can be appropriately selected according to a purpose, as long as the highly water-absorbent material has the above-mentioned absorbency. However, diatomaceous earth and volcanic rocks are preferred, because when the water absorbency of these materials decreases due to the repeated use of the support, the water absorbency can be restored by polishing and removing their surface layers.

The water-absorbent material may be appropriately synthesized, or a commercially available product may be used as the water-absorbent material.

Examples of commercially available products include products that originally have a different intended purpose, but have a water-absorbing function. Examples thereof include, but are not limited to, diapers and sanitary napkins containing water-absorbent polymers, and water-absorbent sheets that absorb moisture, such as dog deodorant sheets (Unicharm Corporation). Among these commercially available products, sheet-like products that do not have three-dimensional processed portions such as gathers and hooks are preferred.

The water-absorbent material is preferably a material having heat resistance. Herein, “heat resistance” refers to the property of a material that does not deform, transform, or decrease in strength when heated at 230° C. Examples of a case where the material deforms, transforms, or decreases in strength include cases where the flatness of the surface of the water-absorbent material is lost due to blistering or thermal deformation, the water-absorbent material cracks, peels, or dissolves, and the water absorption capability decreases. The temperature for the heat resistance is set at 230° C., because the heat resistance limit of printing media such as cotton fabric and polyester fabric is around 230° C.

If the water-absorbent material is heat-resistant, the printing medium on which an image is printed can be subjected to a heat-fixing process without being removed from and attached to the unit, so that the number of steps decreases and the productivity improves.

The water-absorbent material having heat resistance is not particularly limited, may be appropriately selected according to a purpose, and examples thereof include, but are not limited to, diatomaceous earth and volcanic rocks.

The diatomaceous earth is a fossilized form of diatoms, which are phytoplankton. The diatomaceous earth includes SiO₂ as a main component (about 90%), Al₂O₃, Fe₂O₃, Na₂O, and the like. The diatomaceous earth is a porous material that is widely used as an interior wall material, an abrasive, and a fireproof material. The heat-resistant temperature of diatomaceous earth is 1000° C. or higher.

The volcanic rocks are formed when magma suddenly cools and solidifies on the earth's surface or near the earth's surface, and include SiO₂ as a main component (45% or more). Depending on the SiO₂ ratio, the volcanic rocks are classified as basalt (from 45% to 52% of SiO₂), basaltic andesite (from 52% to 57% of SiO₂), andesite (from 57% to 63% of SiO₂), dacite (from 63% to 69% of SiO₂), and rhyolite (more than 69% of SiO₂). The heat-resistant temperature of basalt is 980° C. and the heat-resistant temperature of andesite is 1000° C. or higher.

In the present disclosure, by using such absorbent materials that are heat resistant, it is possible to prevent deterioration of the support, even when the heat pressing operation is repeatedly performed. Note that the support may be replaced after each heat pressing operation.

The size and the structure of the support are not particularly limited and can be appropriately selected according to a purpose.

The shape of the support is not particularly limited and can be appropriately selected according to a purpose. However, a plate shape is preferable, and it is more preferable that an end portion of a support surface of the support that supports the printing medium, has a slope shape or a round shape.

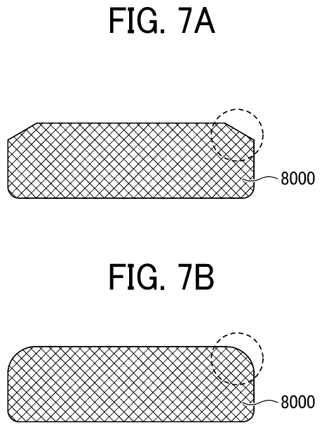

FIG. 7A is a schematic explanatory diagram illustrating the support having a slope shape. FIG. 7B is a schematic explanatory diagram illustrating the support having a round shape. An area surrounded by a dotted line in each of FIGS. 7A and 7B indicates the end portion of the support surface that supports the printing medium.

When the end portion of the support surface of the support 8000 that supports the printing medium has a slope shape or a round shape, the support is prevented from undergoing thermoplastic deformation and forming press marks, even under the heat and stress concentration during heat pressing. This is particularly effective when the support 8000 includes a synthetic fiber such as a polyester fabric.

When the support is repeatedly used, the water absorbency may decrease and thermal deterioration may occur. Therefore, the support is preferably a member that is attachable to and detachable from the unit and can be replaced or washed.

The support that can be replaced is not particularly limited, and can be appropriately selected according to a purpose. Preferred examples thereof include, but are not limited to, an absorbent sheet including a polymer absorbing agent and a non-woven fabric. The polymer absorbing agent is also referred to as a superabsorbent polymer, and is not particularly limited and can be appropriately selected according to a purpose.

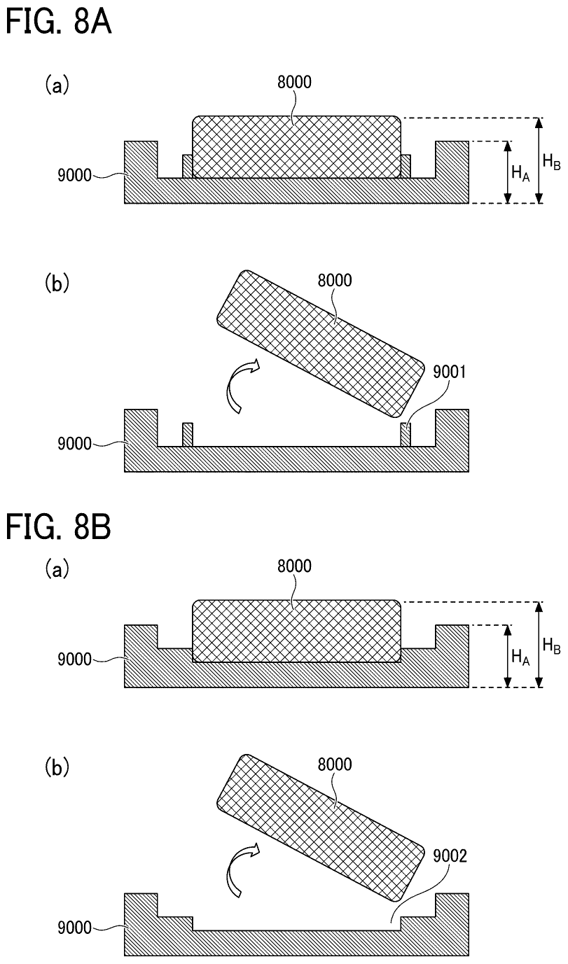

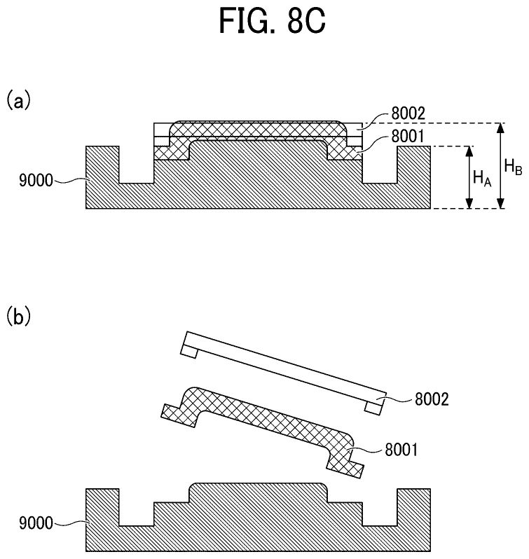

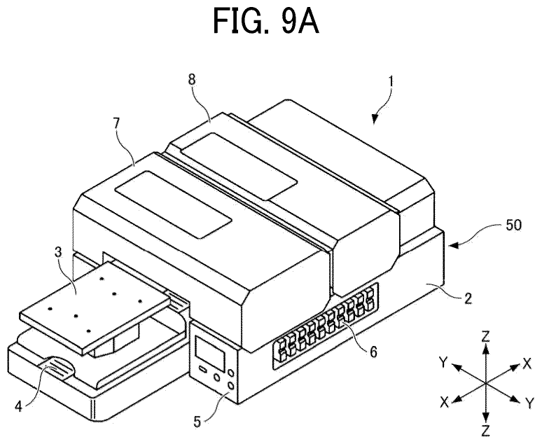

FIG. 8A is a schematic explanatory diagram illustrating a method of attaching the support to the pallet in the unit. FIG. 8A(b) illustrates an example in which a fitting protrusion 9001 used for fitting the support 8000 is provided at a contact surface of the pallet 9000 with the support 8000.

FIG. 8B is a schematic explanatory diagram illustrating a method of attaching the support to the pallet in the unit. FIG. 8B(b) illustrates an example in which a fitting recess 9002 used for fitting the support 8000 is provided at the contact surface of the pallet 9000 with the support 8000.

FIG. 8C is a schematic explanatory diagram illustrating a method of attaching the support to the pallet in the unit. FIG. 8C(b) illustrates an example in which a support 8001 is fixed to the pallet 9000 by a support fixing frame 8002. This example is particularly suitable when a water-absorbent sheet is used as the water-absorbent material.

According to the mounting method illustrated in FIGS. 8A to 8C above, the support can be easily attached to and detached from the unit, which is preferable.

As illustrated in FIGS. 8A(a) and 8B(a), it is preferable that a height H_{B} of at least a part of the support 8000 is higher than a height H_{A} of the frame of the pallet 9000 in the unit.

Further, as illustrated in FIG. 8C(a), it is preferable that the height H_{B} of the support 8001 and the support fixing frame 8002 is higher than the height H_{A} of the frame of the pallet 9000 in the unit.

Herein, the “height H_{A} of the frame of the pallet in the unit” refers to the distance from the bottom portion of the pallet 9000 to the top surface of the pallet 9000, as illustrated in FIGS. 8A to 8C. The “height H_{B} of at least a part of the support” refers to the distance from the bottom portion of the pallet 9000 to the top surface of the support 8000 (the support 8001 or the support fixing frame 8002), as illustrated in FIGS. 8A to 8C.

Thus, during heat-fixing, the contact surface between the printing medium and the heat pressing surface of the heat pressing machine serving as the heating device only includes an area of the printing medium supported by the support, and thus, non-contact areas are not subjected to heat pressing. Accordingly, a gap is formed through which steam can escape and the periphery of the support is not sealed, which makes it possible to maintain the water absorbency of the water-absorbent material.

### <Printing Medium>

The printing medium is not particularly limited and can be appropriately selected according to a purpose. Examples of the printing medium include, but are not limited to, clothing made of cotton, polyester, and mixed fabrics thereof.

Herein, the terms “recording medium,” “media,” and “printing material” are all used synonymously.

### <Ink>

The ink including the white ink and the color ink is not particularly limited and can be appropriately selected according to a purpose. Preferably, the ink contains an organic solvent, water, a pigment, a resin, and an additive, and may contain other components, if desired.

Herein, the “ink” may be simply referred to as “water-based pigment ink.”

### <<Organic Solvent>>

The organic solvent is not particularly limited and can be appropriately selected according to a purpose. For example, a water-soluble organic solvent can be used. Examples of the water-soluble organic solvent include, but are not limited to, polyhydric alcohols, ethers such as polyhydric alcohol alkyl ethers and polyhydric alcohol aryl ethers, heterocyclic compounds containing nitrogen, amides, amines, and compounds containing sulfur.

Specific examples of the water-soluble organic solvent include, but are not limited to, polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol; polyhydric alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyhydric alcohol aryl ethers such as ethylene glycol monophenyl ether and ethylene glycol monobenzyl ether; heterocyclic compounds containing nitrogen such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethylpropionamide, and 3-butoxy-N,N-dimethylpropionamide; amines such as monoethanolamine, diethanolamine, and triethylamine; compounds containing sulfur such as dimethyl sulfoxide, sulfolane, and thiodiethanol, propylene carbonate, and ethylene carbonate.

Among these organic solvents, it is preferable to use an organic solvent having a boiling point of 250° C. or lower, because such an organic solvent not only functions as a wetting agent, but also has good drying properties.

In addition to the above-mentioned compounds, polyol compounds having 8 or more carbon atoms and glycol ether compounds are also preferably used as the water-soluble organic solvent.

Specific examples of the polyol compounds having 8 or more carbon atoms include, but are not limited to, 2-ethyl-1,3-hexanediol and 2,2,4-trimethyl-1,3-pentanediol.

Specific examples of the glycol ether compounds include, but are not limited to, polyhydric alcohol alkyl ethers such as glycol ethers including ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, triethylene glycol monobutyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, and dipropylene glycol mono-iso-propyl ether; and polyhydric alcohol aryl ethers such as ethylene glycol monophenyl ether and ethylene glycol monobenzyl ether.

The content of the organic solvent is not particularly limited and can be appropriately selected according to a purpose. However, considering the drying properties and the discharge reliability of the ink, the content of the organic solvent is preferably 10 mass % or more and 60 mass % or less, and more preferably 20 mass % or more and 60 mass % or less, with respect to the total amount of the ink.

### <<Water>>

The type of water is not particularly limited and can be appropriately selected according to a purpose.

The content of water is not particularly limited and can be appropriately selected according to a purpose. However, considering the drying properties and the discharge reliability of the ink, the content of water is preferably 10 mass % or more and 90 mass % or less, and more preferably 20 mass % or more and 60 mass % or less, with respect to the total amount of the ink.

### <<Pigment>>

The pigment is not particularly limited and can be appropriately selected according to a purpose. For example, inorganic pigments and organic pigments can be used. These pigments may be used alone or in combination of two or more types. Moreover, a mixed crystal may be used as the pigment.

Examples of the pigment that can be used include, but are not limited to, black pigments, yellow pigments, magenta pigments, cyan pigments, white pigments, green pigments, orange pigments, glossy color pigments such as gold and silver pigments, and metallic pigments.

Examples of the inorganic pigment that can be used include, but are not limited to, titanium oxide, iron oxide, calcium carbonate, barium sulfate, aluminum hydroxide, barium yellow, cadmium red, chrome yellow, and carbon black produced by a known method such as a contact method, a furnace method, or a thermal method.

Examples of the organic pigment that can be used include, but are not limited to, azo pigments, polycyclic pigments (such as phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (such as basic dye chelates and acidic dye chelates), nitro pigments, nitroso pigments, and aniline black. Among these pigments, pigments having good affinity for solvents are preferably used.

In addition, hollow resin particles and inorganic hollow particles can also be used. Specific examples of the pigments include, but are not limited to, the pigments mentioned below.

Examples of black pigments include, but are not limited to, carbon blacks (C.I. Pigment Black 7) such as furnace black, lamp black, acetylene black, and channel black; metals such as copper, iron (C.I. Pigment Black 11), and titanium oxide; and organic pigments such as aniline black (C.I. Pigment Black 1).

Examples of color pigments include, but are not limited to, C.I. Pigment Yellow 1, C.I. Pigment Yellow 3, C.I. Pigment Yellow 12, C.I. Pigment Yellow 13, C.I. Pigment Yellow 14, C.I. Pigment Yellow 17, C.I. Pigment Yellow 24, C.I. Pigment Yellow 34, C.I. Pigment Yellow 35, C.I. Pigment Yellow 37, C.I. Pigment Yellow 42 (yellow iron oxide), C.I. Pigment Yellow 53, C.I. Pigment Yellow 55, C.I. Pigment Yellow 74, C.I. Pigment Yellow 81, C.I. Pigment Yellow 83, C.I. Pigment Yellow 95, C.I. Pigment Yellow 97, C.I. Pigment Yellow 98, C.I. Pigment Yellow 100, C.I. Pigment Yellow 101, C.I. Pigment Yellow 104, C.I. Pigment Yellow 108, C.I. Pigment Yellow 109, C.I. Pigment Yellow 110, C.I. Pigment Yellow 117, C.I. Pigment Yellow 120, C.I. Pigment Yellow 138, C.I. Pigment Yellow 150, C.I. Pigment Yellow 153, C.I. Pigment Yellow 155, C.I. Pigment Yellow 180, C.I. Pigment Yellow 185, C.I. Pigment Yellow 213, C.I. Pigment Orange 5, C.I. Pigment Orange 13, C.I. Pigment Orange 16, C.I. Pigment Orange 17, C.I. Pigment Orange 36, C.I. Pigment Orange 43, C.I. Pigment Orange 51, C.I. Pigment Red 1, C.I. Pigment Red 2, C.I. Pigment Red 3, C.I. Pigment Red 4, C.I. Pigment Red 5, C.I. Pigment Red 17, C.I. Pigment Red 22, C.I. Pigment Red 23, C.I. Pigment Red 31, C.I. Pigment Red 38, C.I. Pigment Red 48:2, C.I. Pigment Red 48:3, C.I. Pigment Red 48:4, C.I. Pigment Red 49:1, C.I. Pigment Red 52:2, C.I. Pigment Red 53:1, C.I. Pigment Red 57:1 (Brilliant Carmine 6B), C.I. Pigment Red 60:1, C.I. Pigment Red 63:1, C.I. Pigment Red 63:2, C.I. Pigment Red 64:1, C.I. Pigment Red 81, C.I. Pigment Red 83, C.I. Pigment Red 88, C.I. Pigment Red 101 (red iron oxide), C.I. Pigment Red 104, C.I. Pigment Red 105, C.I. Pigment Red 106, C.I. Pigment Red 108 (Cadmium Red), C.I. Pigment Red 112, C.I. Pigment Red 114, C.I. Pigment Red 122 (Quinacridone Magenta), C.I. Pigment Red 123, C.I. Pigment Red 146, C.I. Pigment Red 149, C.I. Pigment Red 166, C.I. Pigment Red 168, C.I. Pigment Red 170, C.I. Pigment Red 172, C.I. Pigment Red 177, C.I. Pigment Red 178, C.I. Pigment Red 179, C.I. Pigment Red 184, C.I. Pigment Red 185, C.I. Pigment Red 190, C.I. Pigment Red 193, C.I. Pigment Red 202, C.I. Pigment Red 207, C.I. Pigment Red 208, C.I. Pigment Red 209, C.I. Pigment Red 213, C.I. Pigment Red 219, C.I. Pigment Red 224, C.I. Pigment Red 254, C.I. Pigment Red 264, C.I. Pigment Violet 1 (Rhodamine Lake), C.I. Pigment Violet 3, C.I. Pigment Violet 5:1, C.I. Pigment Violet 16, C.I. Pigment Violet 19, C.I. Pigment Violet 23, C.I. Pigment Violet 38, C.I. Pigment Blue 1, C.I. Pigment Blue 2, C.I. Pigment Blue 15 (Phthalocyanine Blue), C.I. Pigment Blue 15:1, C.I. Pigment Blue 15:2, C.I. Pigment Blue 15:3, C.I. Pigment Blue 15:4 (Phthalocyanine Blue), C.I. Pigment Blue 16, C.I. Pigment Blue 17:1, C.I. Pigment Blue 56, C.I. Pigment Blue 60, C.I. Pigment Blue 63, C.I. Pigment Green 1, C.I. Pigment Green 4, C.I. Pigment Green 7, C.I. Pigment Green 8, C.I. Pigment Green 10, C.I. Pigment Green 17, C.I. Pigment Green 18, and C.I. Pigment Green 36.

The content of the pigment is preferably 0.1 mass % or more and 15 mass % or less, and more preferably 1 mass % or more and 10 mass % or less, with respect to the total amount of the ink, to improve the image density and achieve good fixability and discharge stability.

Examples of methods of dispersing the pigment to obtain ink include, but are not limited to, (1) a method of introducing a hydrophilic functional group into a pigment to obtain a self-dispersing pigment, (2) a method of coating the surface of a pigment with a resin to disperse the pigment, and (3) a method of using a dispersant to disperse the pigment.

An example of the above-mentioned (1) method of introducing a hydrophilic functional group into a pigment to obtain a self-dispersing pigment includes a method of adding a functional group such as a sulfone group or a carboxyl group to a pigment (for example, carbon) to obtain a pigment that is dispersible in water.

An example of the above-mentioned (2) method of coating the surface of a pigment with a resin to disperse the pigment include, but are not limited to, a method of encapsulating the pigment in microcapsules to obtain a pigment that is dispersible in water. A pigment in which the surface of the pigment is coated with a resin to disperse the pigment may be referred to as a resin-coated pigment. When the surface of a pigment is coated with a resin to disperse the pigment, not all pigment particles blended in the ink may be coated with the resin. That is, uncoated pigment particles and partially coated pigment particles may be dispersed in the ink within in a range in which an effect of the present disclosure is not impaired.

An example of the above-mentioned (3) method of using a dispersant to disperse the pigment includes a method of dispersing the pigment by using a known low-molecular-type dispersant or polymer-type dispersant, such as a surfactant. For example, depending on the pigment, anionic surfactants, cationic surfactants, amphoteric surfactants, and nonionic surfactants may be used as the dispersant. PAIONIN RT-100 (a nonionic surfactant) manufactured by Takemoto Oil & Fat Co., Ltd. and a sodium naphthalene sulfonate formalin condensate can also be suitably used as the dispersant. One type of dispersant may be used alone, or two or more types of dispersants may be used in combination.

### —Pigment Dispersion—

The pigment can be mixed with materials such as water and organic solvents to obtain an ink. It is also possible to manufacture the ink by mixing the pigment with other materials such as water and a dispersant to prepare a pigment dispersion, and then, mixing the pigment dispersion with materials such as water and an organic solvent.

The pigment dispersion may be obtained by mixing and dispersing water, a pigment, a pigment dispersant, and, if desired, other components, and adjusting the particle diameter. A disperser may be used to disperse the components. If desired, coarse particles in the pigment dispersion are filtered by using a filter, a centrifugal separator or the like, and the pigment dispersion is preferably deaerated.

The particle diameter of the pigments in the pigment dispersion is not particularly limited. However, to obtain good dispersion stability of the pigment and improve the discharge stability and the image quality such as the image density, the maximum frequency of the particle diameter calculated in terms of the maximum number is preferably 20 nm or more and 500 nm or less, and more preferably 20 nm or more and 150 nm or less. The particle diameter of the pigment can be measured by using a particle size analyzer (NANOTRAC WAVE II-UT151, manufactured by Microtrac MRB Co., Ltd.).

The content of the pigment in the pigment dispersion is not particularly limited and can be appropriately selected according to a purpose. However, to obtain good discharge stability and increase the image density, the content of the pigment in the pigment dispersion is preferably 0.1 mass % or more and 50 mass % or less, and more preferably 0.1 mass % or more and 30 mass % or less, with respect to the total amount of the pigment dispersion.

### <<Resin>>

The resin is not particularly limited and can be appropriately selected according to a purpose. Examples of the resin include, but are not limited to, urethane resins, polyester resins, acrylic resins, vinyl acetate resins, styrene resins, butadiene resins, styrene-butadiene resins, vinyl chloride resins, acrylic-styrene resins, and acrylic-silicone resins. Resin particles formed of these resins may also be used. The resin particles can be dispersed in water as a dispersion medium to form a resin emulsion, and the resin emulsion can be mixed with materials such as coloring materials and organic solvents to obtain an ink. The resin particles may be appropriately synthesized, or a commercially available product may be used as the resin particles.

These resin particles may be used alone or in combination of two or more types of resin particles.

The volume average particle diameter of the resin particles is not particularly limited and can be appropriately selected according to a purpose. However, to obtain good fixability and high image hardness, the volume average particle diameter is preferably 10 nm or more and 1,000 nm or less, more preferably 10 nm or more and 200 nm or less, and even more preferably 10 nm or more and 100 nm or less. For example, the volume average particle diameter can be measured by using a particle size analyzer (NANOTRAC WAVE II-UT151, manufactured by Microtrac MRB Co., Ltd.).

The content of the resin is not particularly limited and can be appropriately selected according to a purpose. However, considering the fixability and the storage stability of the ink, the content of the resin is preferably 1 mass % or more and 30 mass % or less, and more preferably 5 mass % or more and 20 mass % or less, with respect to the total amount of the ink.

The particle diameter of the solid content components in the ink is not particularly limited and can be appropriately selected according to a purpose. However, to improve the discharge stability and the image quality such as the image density, the maximum frequency of the particle diameter of the solid content components in the ink calculated in terms of the maximum number is preferably 20 nm or more and 1000 nm or less, and more preferably 20 nm or more and 150 nm or less. The solid content includes the resin particles, the pigment particles, and the like. The particle diameter can be measured by using a particle size analyzer (NANOTRAC WAVE II-UT151, manufactured by Microtrac MRB Co., Ltd.).

### <<Additives>>

If desired, additives such as surfactants, antifoaming agents, preservatives/fungicides, rust inhibitors, and pH adjusters may be added to the ink.

In addition to the surfactants mentioned above, for example, silicone surfactants, fluorosurfactants, acetylene glycol surfactants, amphoteric surfactants (excluding the above-mentioned amphoteric surfactants), nonionic surfactants (excluding the above-mentioned nonionic surfactants), and anionic surfactants (excluding the above-mentioned anionic surfactants) can be used as the surfactant.

The silicone surfactants are not particularly limited and can be appropriately selected according to a purpose. However, it is preferable that the silicone surfactants do not decompose even at high pH (pH 11 to 14). Examples of silicone surfactants that do not decompose even at high pH (pH 11 to 14) include, but are not limited to, polydimethylsiloxane modified in a side chain, polydimethylsiloxane modified at both ends, polydimethylsiloxane modified at one end, and polydimethylsiloxane modified at both side chain ends. Among these surfactants, surfactants having a polyoxyethylene group or a polyoxyethylene polyoxypropylene group as the modified group are preferably used, to improve the hydrophilicity and increase the solubility in water.

These surfactants may be appropriately synthesized, or a commercially available product may be used as the surfactant. For example, the commercially available products are available from BYK-Chemie GmbH, Shin-Etsu Chemical Co., Ltd., Toray Dow Corning Silicone Co., Ltd., Nihon Emulsion Co., Ltd., and Kyoeisha Chemical Co., Ltd.

A polyether-modified silicone surfactant can also be used as the silicone surfactant.

The polyether-modified silicone surfactant is not particularly limited and can be appropriately selected according to a purpose. Examples thereof include, but are not limited to, a surfactant obtained by introducing a polyalkylene oxide structure expressed by General Formula (S-1) below into the side chain of the Si moiety of dimethylpolysiloxane.

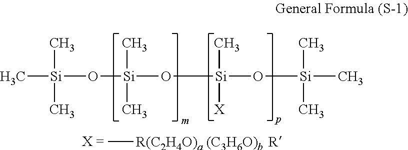

(in General Formula (S-1), m, p, a, and b each independently represent an integer, R represents an alkylene group, and R′ represents an alkyl group)

Commercially available products can be used as the polyether-modified silicone surfactant mentioned above. Examples of the commercially available products include, but are not limited to, products of the trade names KF-353, KF-640, KF-642, KF-643, and KF-644 (all manufactured by Shin-Etsu Chemical Co., Ltd.), EMALEX-SS-5051 (manufactured by Nihon Emulsion Co., Ltd.), BYK-345, BYK-347, BYK-348, BYK-375, and BYK-377 (all manufactured by BYK Chemical Japan K.K.), SILFACE SAG002, SILFACE SAG003, SILFACE SAG005, SILFACE SAG503A, and SILFACE SAG008 (all manufactured by Nissin Chemical Co., Ltd.), and TEGO_Wet_KL245, TEGO_Wet_250, TEGO_Wet_260, TEGO_Wet_265, TEGO_Wet_270, and TEGO_Wet_280 (all manufactured by Evonik Japan Co., Ltd.).

The fluorosurfactants are not particularly limited and can be appropriately selected according to a purpose. However, from the viewpoint of low foamability, it is preferable to use perfluoroalkyl sulfonic acid compounds, perfluoroalkyl carboxylic acid compounds, perfluoroalkyl phosphate ester compounds, perfluoroalkyl ethylene oxide adducts, and polyoxyalkylene ether polymer compounds having a perfluoroalkyl ether group in a side chain.

Examples of the perfluoroalkyl sulfonic acid compounds include, but are not limited to, perfluoroalkyl sulfonic acid and perfluoroalkyl sulfonic acid salts.

Examples of the perfluoroalkyl carboxylic acid compounds include, but are not limited to, perfluoroalkyl carboxylic acid and perfluoroalkyl carboxylic acid salts.

Examples of the polyoxyalkylene ether polymer compounds having a perfluoroalkyl ether group in a side chain include, but are not limited to, sulfate ester salts of polyoxyalkylene ether polymers having a perfluoroalkyl ether group in a side chain, and salts of polyoxyalkylene ether polymers having a perfluoroalkyl ether group in a side chain.

Examples of the counter ions of the salts in these fluorosurfactants include, but are not limited to, Li, Na, K, NH₄, NH₃CH₂CH₂OH, NH₂(CH₂CH₂OH)₂, and NH(CH₂CH₂OH)₃.

Among these fluorosurfactants, fluorosurfactants represented by General Formulas (F-1) and (F-2) below are preferred.

CF₃CF₂(CF₂CF₂)ₘ—CH₂CH₂O(CH₂CH₂O)ₙH General Formula (F-1)

In the compound expressed by General Formula (F-1) above, to impart water solubility, m is preferably an integer from 0 to 10 and n is preferably an integer from 0 to 40.

CₙF₂ₙ₊₁—CH₂CH(OH)CH₂—O—(CH₂CH₂O)ₐ—Y General Formula (F-2)

In the compound expressed by General Formula (F-2) above, Y represents H, CₘF₂ₘ₊₁ (m being an integer from 1 to 6), CH₂CH(OH)CH₂—CₘF₂ₘ₊₁ (m being an integer from 4 to 6), or CₚH₂ₚ₊₁ (p being an integer from 1 to 19). n is an integer from 1 to 6. a is an integer from 4 to 14.

The fluorosurfactant is preferably a compound having 2 to 16 fluorine-substituted carbon atoms, and more preferably a compound having 4 to 16 fluorine-substituted carbon atoms.

A commercially available product may be used as the fluorosurfactant. Examples of the commercially available product of the fluorosurfactant include, but are not limited to, products of the trade names SURFLON S-242, SURFLON S-243, SURFLON S-420, and SURFLON S-431 (all manufactured by AGC Seimi Chemical Co., Ltd.); MEGAFACE F-251, MEGAFACE F-430, MEGAFACE F-444, MEGAFACE F-477, MEGAFACE F-552, MEGAFACE F-553, and MEGAFACE F-554 (all manufactured by DIC Corporation); CAPSTONE FS-10, CAPSTONE FS-30, CAPSTONE FS-31, CAPSTONE FS-34, CAPSTONE FS-35, CAPSTONE FS-51, CAPSTONE FS-60, CAPSTONE FS-61, CAPSTONE FS-63, CAPSTONE FS-64, CAPSTONE FS-65, and CAPSTONE FS-3100 (all manufactured by DuPont Corporation); FTERGENT 212M, FTERGENT 215M, FTERGENT 250, FTERGENT 251, FTERGENT 222F, and FTERGENT 245F (all manufactured by Neos Co., Ltd.), and POLYFOX PF-136A, POLYFOX PF-156A, and POLYFOX PF-151N (all manufactured by Kitamura Chemicals Co., Ltd.). Among these commercially available products, CAPSTONE FS-3100 and CAPSTONE FS-34 manufactured by Chemours Corporation, FTERGENT 250 and FTERGENT 251 manufactured by Neos Co., Ltd., and POLYFOX PF-151N manufactured by Kitamura Chemicals Co., Ltd. are preferred, because these products provide good printing quality, in particular, improved color development, permeation into paper, wettability, and uniform dyeing.

The acetylene glycol surfactants are not particularly limited, may be appropriately selected according to a purpose, and examples thereof include, but are not limited to, a nonionic surfactant having an acetylene group at the center and having a symmetrical structure. The nonionic surfactant serves as a “wetting agent that does not easily foam” and thus, is a surfactant suitable for responding to environmental issues.

A commercially available product may be used as the acetylene glycol surfactant. Examples of the commercially available product used as the acetylene glycol surfactant include, but are not limited to, products of the trade names SURFYNOL 104E, SURFYNOL 420, SURFYNOL 440, SURFYNOL 465, SURFYNOL SE, SURFYNOL SE-F, SURFYNOL PSA-336, SURFYNOL DF110D, SURFYNOL DF58, OLFINE E1004, OLFINE E1010, OLFINE E1020, OLFINE PD-001, OLFINE PD-002W, OLFINE PD-004, OLFINE PD-005, OLFINE EXP.4001, OLFINE EXP.4200, OLFINE EXP.4123, and OLFINE EXP.4300 (all manufactured by Nissin Chemical Co., Ltd.).

The amphoteric surfactants are not particularly limited and can be appropriately selected according to a purpose. Examples of the amphoteric surfactants include, but are not limited to, lauryl aminopropionate, lauryl dimethyl betaine, stearyl dimethyl betaine, and lauryl dihydroxyethyl betaine.

The nonionic surfactants are not particularly limited and can be appropriately selected according to a purpose. Examples of the nonionic surfactants include, but are not limited to, polyoxyethylene alkylphenyl ether, polyoxyethylene alkyl ester, polyoxyethylene alkyl amine, polyoxyethylene alkyl amide, polyoxyethylene-propylene block polymer, sorbitan fatty acid ester, polyoxyethylene sorbitan fatty acid ester, and ethylene oxide adducts of acetylene alcohol.

The anionic surfactants are not particularly limited and can be appropriately selected according to a purpose. Examples of the anionic surfactants include, but are not limited to, polyoxyethylene alkyl ether acetate, dodecylbenzene sulfonate, laurate, and salts of polyoxyethylene alkyl ether sulfate.

The content of the surfactant is not particularly limited and can be appropriately selected according to a purpose. However, to achieve excellent wettability and discharge stability and improve the image quality, the content of the surfactant is preferably 0.001 mass % or more and 5 mass % or less, and more preferably, 0.05 mass % or more and 5 mass % or less, with respect to the total amount of the ink.

### —Antifoaming Agent—

The surfactant used as one of the other components can be used as an antifoaming agent.

The antifoaming agent is not particularly limited and can be appropriately selected according to a purpose. Examples of the antifoaming agent include, but are not limited to, silicone-based antifoaming agents, polyether-based antifoaming agents, and fatty acid ester-based antifoaming agents. Among these antifoaming agents, silicone-based antifoaming agents are preferred to achieve an excellent defoaming effect.

These antifoaming agents may be used alone or in combination of two or more types of antifoaming agents.

### —pH Adjuster—

The pH adjuster is not particularly limited and may be appropriately selected according to a purpose, as long as the pH adjuster can adjust the pH to 7 or higher. Examples of the pH adjuster include, but are not limited to, amines such as diethanolamine and triethanolamine.

### —Preservative/Fungicide—

The preservative/fungicide is not particularly limited, can be appropriately selected according to a purpose, and examples thereof include, but are not limited to, 1,2-benzisothiazolin-3-one.

### —Rust Inhibitor—

The rust inhibitor is not particularly limited, can be appropriately selected according to a purpose, and examples thereof include, but are not limited to, acid sulfite and sodium thiosulfate.

The content of the surfactant is not particularly limited and can be appropriately selected according to a purpose. However, to achieve excellent wettability and discharge stability and improve the image quality, the content of the surfactant is preferably 0.001 mass % or more and 5 mass % or less, and more preferably, 0.05 mass % or more and 5 mass % or less, with respect to the total amount of the ink.

Examples of a method of qualitatively and quantitatively determining the organic solvent, the resin, the coloring material, and other components contained in the ink include, but are not limited to, a gas chromatography mass spectrometry (GC-MS) method. Examples of a measurement device using such a gas chromatography mass spectrometry (GC-MS) method include, but are not limited to, GCMS-QP2020NX (manufactured by Shimadzu Corporation).

The amount of water contained in the ink can be measured by general methods such as a method of quantifying the amount of volatile components by gas chromatography mass spectrometry (GC-MS) or a method of measuring a mass change and the like by thermogravimetry-differential thermal analysis (TG-DTA).

The physical properties of the ink are not particularly limited and can be appropriately selected according to a purpose. For example, it is preferable that the viscosity, the surface tension, the pH, and the like are within the ranges mentioned below.

The viscosity of the ink at 25° C. is preferably 5 mPa*s or more and 30 mPa*s or less, and more preferably 5 mPa*s or more and 25 mPa*s or less, to improve the printing density and the character quality and to obtain good discharge properties. Here, the viscosity can be measured by using, for example, a rotational viscometer (RE85L manufactured by Toki Sangyo Co., Ltd.). The measurement conditions include a temperature of 25° C., a standard cone rotor (1°34′×R24), a sample liquid volume of 1.2 mL, a rotation speed of 50 rpm, and a measurement time of 3 minutes.

The surface tension of the ink is preferably 35 mN/m or less, and more preferably 32 mN/m or less at 25° C., to ensure that the ink is appropriately leveled on the recording medium and the drying time of the ink is shortened.

The pH of the ink is preferably from 7 to 12, and more preferably from 8 to 11, to prevent corrosion of metal members in contact with the ink.

### <Pretreatment Liquid>

The pretreatment liquid is not particularly limited and can be appropriately selected according to a purpose. For example, the pretreatment liquid preferably contains an aggregating agent, an organic solvent, and water, and if desired, may contain a surfactant, an antifoaming agent, a pH adjuster, a preservative/fungicide, a rust inhibitor, and the like.

The organic solvent, the surfactant, the antifoaming agent, the pH adjuster, the preservative/fungicide, and the rust inhibitor may be similar to the materials used in the ink or may include materials used in known treatment liquids.

The aggregating agent is not particularly limited, can be appropriately selected according to a purpose, and examples thereof include, but are not limited to, water-soluble cationic polymers, acids, and polyvalent metal salts.

Here, an embodiment of a printing apparatus of the present disclosure will be described with reference to the drawings. However, the present disclosure is not limited to these embodiments in any way.

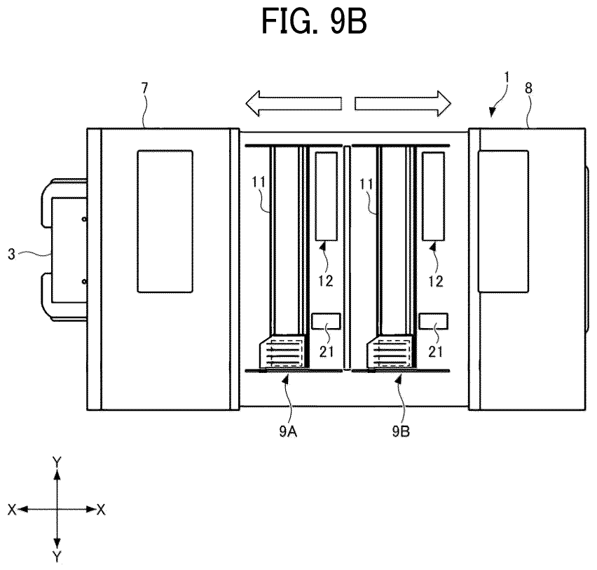

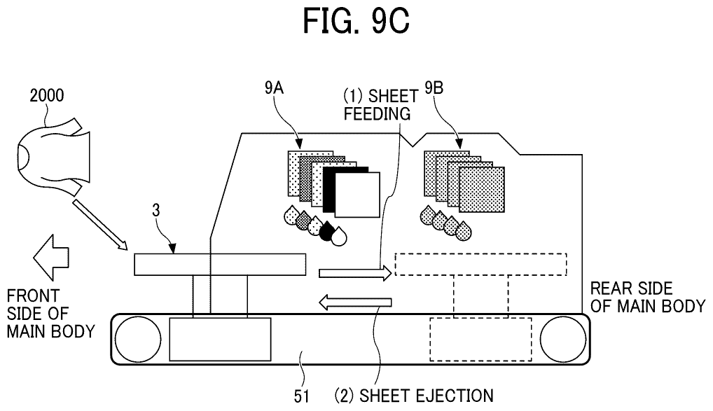

FIG. 9A is a schematic perspective view of a DTG printer incorporating a pretreatment liquid discharge head as a printing apparatus.

FIG. 9B is a schematic explanatory view of the DTG printer of FIG. 9A incorporating the pretreatment liquid discharge head, viewed from above.

FIG. 9C is a schematic cross-sectional diagram illustrating an operation of a stage in the DTG printer of FIG. 9A incorporating the pretreatment liquid discharge head.

A DTG printer 1 incorporating a pretreatment liquid discharge head includes a pretreatment liquid discharge carriage 9B provided separately from a printing ink discharge carriage 9A. The DTG printer 1 can discharge a pretreatment liquid and sequentially print images with ink by temporarily pulling back to the rear of the device a platen stage 3 on which a printing medium is set and conveying the printing medium on the platen toward the front of the device while performing a printing operation.

The pretreatment liquid discharge carriage 9B and the printing ink discharge carriage 9A discharge the pretreatment liquid and the printing ink while performing scanning in a direction perpendicular to a conveyance direction of the platen stage 3 using a guide rod 11 as a support. A scanning/discharge operation of the pretreatment liquid discharge carriage 9B and the printing ink discharge carriage 9A is controlled by generating a discharge waveform in a head drive circuit 12 while an encoder sensor 21 reads a scale of an encoder sheet.

In addition to the components described above, the DTG printer 1 may also include a printer side panel 2, a stage feed portion cover (bellows sheet) 4, an operation panel 5, a pretreatment liquid/ink cartridge 6, an ink discharge carriage portion cover 7, a pretreatment liquid discharge carriage portion cover 8, a printer back panel 50, and a stage feed belt 51.

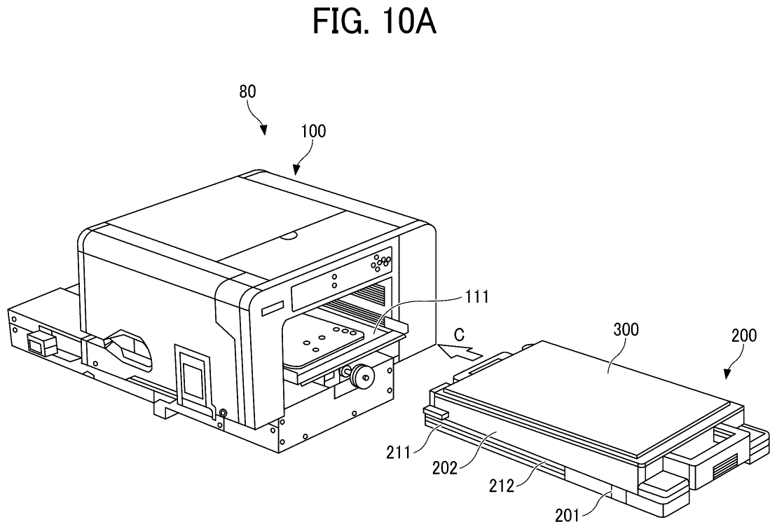

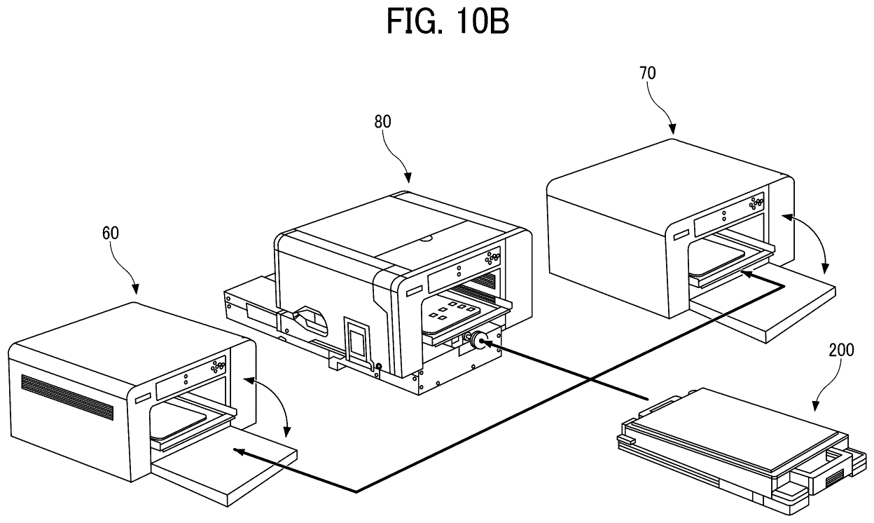

FIG. 10A is a schematic perspective view of a DTG printer compatible with a media mounting cassette as a printing apparatus.

FIG. 10B is a schematic perspective view of the DTG printer of FIG. 10A using a media mounting cassette.

A DTG printer 80 compatible with a media mounting cassette is an apparatus in which the printing medium is mounted in a cassette-shaped unit 200. This apparatus uses the cassette-shaped unit 200 instead of the plate-shaped platen stage illustrated in FIGS. 9A and 9B. The cassette together with the printing medium is pulled back to the rear of the apparatus and the cassette is conveyed to the front of the apparatus, while the medium is printed.

The unit 200 includes a cassette base 201 serving as a base member, and a support 300 supporting the printing medium in a flat state. The cassette base 201 includes an outer periphery cover 202 serving as an outer periphery cover member.

The unit 200 includes a groove portion 211 and a protrusion-shaped portion 212 fitted into a recess-shaped portion of a stage 111. An apparatus main body 100 includes a member used for fixing the unit 200 and the stage 111 together after the unit 200 is slid to be set on the stage 111 via the recess-shaped portion of the stage 111 and the protrusion-shaped portion 212.

When the unit 200 in which the printing medium is held on the support 300 is mounted on the stage 111 of the apparatus main body 100, the unit 200 is slid onto the stage 111 in the direction of an arrow C, to be mounted to the stage 111.

As illustrated in FIG. 10B, by providing a pretreatment device 70 and a fixing device 60 that have the same slot shape, the process can be implemented with a simple slot-in/out operation, without removing and mounting again the printing medium mounted in the cassette.

Aspects of the present disclosure include the following aspects, for example.

According to a first aspect,
a unit is attachable to and detachable from a printing apparatus,
the unit includes a support to support a printing medium, and
the support comprises a water-absorbent material.

According to a second aspect,
in the unit according to the first aspect, the water-absorbent material is heat resistant.

According to a third aspect,
in the unit according to the first aspect or the second aspect, the support is attachable to and detachable from the unit.

According to a fourth aspect,
in the unit according to any one of the first aspect to the third aspect, the water-absorbent material comprises diatomaceous earth.

According to a fifth aspect,
in the unit according to any one of the first aspect to the fourth aspect, the water-absorbent material comprises volcanic rock.

According to a sixth aspect,
in the unit according to any one of the first aspect to the fifth aspect, the support includes an absorbent sheet including a polymer absorbing agent and a non-woven fabric.

According to a seventh aspect,
in the unit according to any one of the first aspect to the sixth aspect, a height of at least a part of the support is higher than a height of a frame of the unit.

According to an eighth aspect,
in the unit according to any one of the first aspect to the seventh aspect, an end portion of a support surface of the support to support the printing medium has a slope shape or a round shape.

According to a ninth aspect,
the unit according to any one of the first aspect to the eighth aspect further includes a joint that is attachable to and detachable from a stage of the printing apparatus.

According to a tenth aspect,
the unit according to any one of the first aspect to the ninth aspect further includes a frame, at a bottom portion of the unit, to cover an outer edge of a stage of the printing apparatus.

According to an eleventh aspect,
the unit according to any one of the first aspect to the tenth aspect further includes a clamping mechanism to clamp an outer edge of a stage of the printing apparatus.

According to the unit according to any one of the first aspect to the eleventh aspect, it is possible to solve the above-described issues of the related art and achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A unit that is attachable to and detachable from a printing apparatus, the unit comprising:
a support to support a printing medium,
the support comprising a water-absorbent material.

2. The unit according to claim 1, wherein the water-absorbent material is heat resistant.

3. The unit according to claim 1, wherein the support is attachable to and detachable from the unit.

4. The unit according to claim 1, wherein the water-absorbent material comprises diatomaceous earth.

5. The unit according to claim 1, wherein the water-absorbent material comprises volcanic rock.

6. The unit according to claim 1, wherein the support includes an absorbent sheet including a polymer absorbing agent and a non-woven fabric.

7. The unit according to claim 1, wherein a height of at least a part of the support is higher than a height of a frame of the unit.

8. The unit according to claim 1, wherein an end portion of a support surface of the support to support the printing medium has a slope shape or a round shape.

9. The unit according to claim 1, further comprising a joint that is attachable to and detachable from a stage of the printing apparatus.

10. The unit according to claim 1, further comprising a frame, at a bottom portion of the unit, to cover an outer edge of a stage of the printing apparatus.

11. The unit according to claim 1, further comprising a clamping mechanism to clamp an outer edge of a stage of the printing apparatus.
